(19) United States
(12) Patent Application Publication
(10) Pub. No.: US 2006/0255282 A1
(43) Pub. Date: Nov. 16, 2006

(54) Semiconductor materials matrix for neutron detection

(75) Inventors: Rebecca J. Nikolic, Oakland, CA (US); Chin Li Cheung, Lincoln, NE (US); Tzu Fang Wang, Danville, CA (US); Catherine E. Reinhardt, Livermore, CA (US)

Correspondence Address: Michael C. Staggs;Attorney for Applicants, Lawrence Livermore National Laboratory, P.O. Box 808, L-703, Livermore, CA, 94551, US

(73) Assignee: The Regents of the University of California

(21) Appl. No.: 11/414,288

(22) Filed: Apr. 27, 2006

Related U.S. Application Data
(60) Provisional application No. 60/675,654, filed on Apr. 27, 2005.

(51) Int. Cl. G01T 3/00

(52) U.S. Cl. 250/390.01

(57) ABSTRACT

Semiconductor-based elements as an electrical signal generation media are utilized for the detection of neutrons. Such elements can be synthesized and used in the form of, for example, semiconductor dots, wires or pillars in the form of semiconductor substrates embedded in matrixes of high cross-section neutron converter materials that can emit charged particles upon interaction with neutrons. These charged particles in turn can generate electron-hole pairs and thus detectable electrical current and voltage in the semiconductor elements. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### RELATED APPLICATION

This application claims priority from U.S. Provisional Patent Application No. 60/675,654, entitled “SEMI-CONDUCTOR NANO-MATERIALS MATRIX FOR NEUTRON DETECTION,” filed on Apr. 27, 2005, and is incorporated by reference in its entirety.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

1. Field of the Invention

The present invention relates to the detection of particles, more particularly, the present invention relates to the detection of neutrons using high cross section converter materials in three dimensional high-efficiency configurations and methods of fabricating such structures.

2. Description of Related Art

Present technology for radiation detection suffers from flexibility and scalability issues. Since neutrons have no charges and do not interact significantly with most materials, special neutron converters such as, pure Boron 10 in solid form are needed to react with neutrons to produce charged particles that can be easily detected by semiconductor devices to generate electrical signals.

A commonly used geometry involves the use of a planar semiconductor detector over which a neutron reactive film has been deposited. Upon a surface of the semiconductor detector is attached a coating that releases ionizing radiation reaction products upon the interaction with a neutron. The ionizing radiation reaction products can then enter into the semiconductor material of the detector thereby creating a charge cloud of electrons and “holes,” which can be sensed to indicate the occurrence of a neutron interaction within the neutron sensitive film. The charges are swept through such configured detectors via methods known by those of ordinary skill in the art and registered as an electrical signal.

Another geometry includes etched trenches, slots, or holes in semiconductor materials having dimensions on the micron scale or larger that are filled with predetermined converter materials and configured with electrodes so as to produce detectors similar to the planar detector geometries discussed above.

A need exists for new and/or improved high-efficiency radiation detectors based on materials having three dimensional hierarchical structures at the micro and at the nano dimensional scale level. The present invention is directed to such a need.

### SUMMARY OF THE INVENTION

Accordingly, the present invention provides a detector having a plurality of embedded converter materials extending into the substrate from only a single predetermined surface of the substrate. Such a detector provides detection efficiencies greater than conventional detectors because the converter materials are configured in voids having at least one dimension that is less than about a mean free path of the reaction-produced particles.

Another aspect of the present invention provides a neutron detector having a plurality of detectors, such as, neutron detectors, each respective detector being configured with embedded converter materials that extend into the substrate from only a single predetermined surface of a substrate. Such a stacked configuration enables collection and comparisons of signals from one or more detectors arranged in the stacked configuration to detect a large dynamic range of neutron flux intensity.

A final aspect of the present invention is directed to a method for producing a neutron detector that includes: configuring a substrate with a matrix of voids that extend from only a single predetermined surface of the substrate, wherein the substrate is capable of producing electron-hole pairs upon interaction with one or more reaction-produced particles; and embedding converter materials within the voids, wherein the embedded converter materials are configured to release the reaction-produced particles upon interaction with one or more received neutrons; and coupling pairs of non-embedded electrodes to predetermined surfaces of the substrate, wherein each electrode of the pairs of electrodes comprises a substantially linear configuration, and wherein signals from resulting electron-hole pairs as received from respective pairs of electrodes are indicative of the received neutrons.

Accordingly, such methods and apparatus of the present invention enable the use of a large amount of high neutron cross-section converter materials to increase the total neutron capture and thus substantially increase neutron detector efficiency. Moreover, the present invention provides beneficial embedded detector arrangements to detect the directions of incoming neutrons by connecting configured semiconductor elements with electrodes and analyzing received signals from each set of the elements. As another beneficial arrangement, stacking of such detectors in a layered configuration increases the neutron capture volume and thus allows the detection of fluxes of neutrons having a broad range of intensities. Such proposed designs can yield drastic improvements in area, such as flexibility, durability, sensitivity, increased detector area, improved electrical signal output, and energy resolution for the next generation of neutron detectors.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 shows the escape probability of charged particles, such as neutrons, being captured for detection.

FIG. 2 shows a cross section of a beneficial generic neutron detector having three-dimensional embedment structures for neutron converter materials.

FIG. 3(a) shows an example neutron semiconductor detector pillar structure of the semiconductor materials.

FIG. 3(b) shows an example neutron semiconductor detector pitted structure of the semiconductor materials.

FIG. 4 shows a stacked detector design for increasing the neutron capture volume.

FIG. 5(a) illustrates an example first stage for the top-down detector fabrication scheme of the present invention.

FIG. 5(b) illustrates an example first stage for the top-down detector fabrication scheme of the present invention.

FIG. 5(c) illustrates an example first stage for the top-down detector fabrication scheme of the present invention.

FIG. 5(d) illustrates an example first stage for the top-down detector fabrication scheme of the present invention.

FIG. 6(a) shows a scanning electron micrograph of the pillar structures fabricated by nanosphere lithography at a predetermined stage of construction.

FIG. 6(b) shows a second scanning electron micrograph of the nanopillar structures fabricated by nanosphere lithography at a different stage of construction.

FIG. 6(c) shows a third scanning electron micrograph of the pillar structures fabricated by nanosphere lithography at a nearly completed stage of construction.

FIG. 7(a) illustrates an example first stage for the bottom-up detector fabrication approach of the present invention.

FIG. 7(b) illustrates an example second stage for the bottom-up detector fabrication approach of the present invention.

FIG. 7(c) illustrates an example third stage for the bottom-up detector fabrication approach of the present invention.

FIG. 7(d) illustrates an example final stage for the bottom-up detector fabrication approach of the present invention.

FIG. 8 shows example detector efficiency data using Boron 10 as the neutron conversion material.

### DETAILED DESCRIPTION OF THE INVENTION

Referring now to the drawings, specific embodiments of the invention are shown. The detailed description of the specific embodiments, together with the general description of the invention, serves to explain the principles of the invention.

Unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contain certain errors necessarily resulting from the standard deviation found in their respective testing measurements.

### General Description

Detectable radiations generated by neutron converter materials upon neutron irradiation usually travel inside the neutron converter materials only for a substantially short distance. Thus, a thick layer of a neutron converter materials (neutron converter materials are defined herein as any material that can react with neutrons to produce secondary radiations, such as gamma rays, charged particles, neutrons of different energy, and/or products from fission or fusion reactions), though perceived to increase the generation of such radiations, actually absorb substantially all of the detectable radiations before they are detected by the semiconductor detection elements.

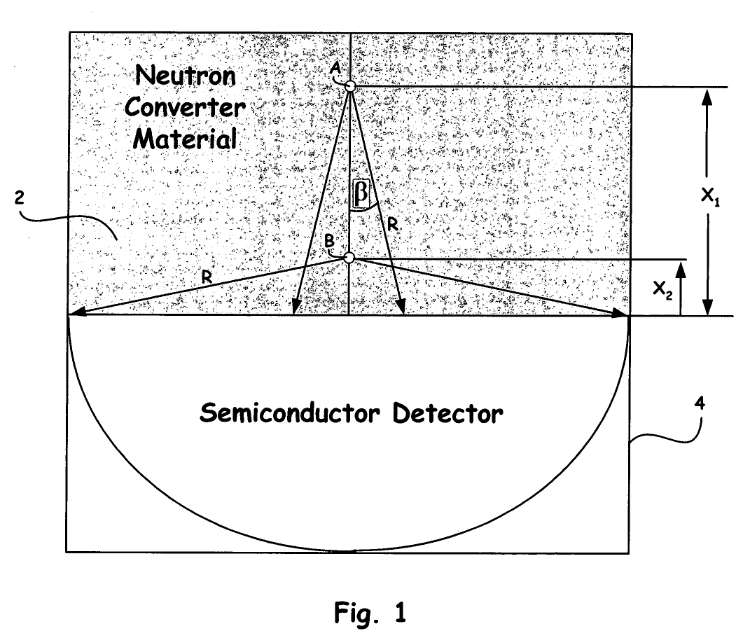

FIG. 1 illustrates such a concept by generically demonstrating the escape probability of charged particles, such as neutrons, being captured for detection. The charged particles emitted from point A within a neutron converter material 2, at a distance X₁ for a detector 4 have very low probability to reach the semiconductor detector. Only forward going particles emitted along a radius R and thus into a cone opening angle defined by β=cos⁻¹(X₁/R), can reach detector 4 and produce signals, the rest of the particles are stopped in converter material 2. For FIG. 1, it is clearly seen that the probability of signal generation for particles emitted from point B, at X₂<X₁<R is much higher than for the ones from point A.

The present invention explores semiconductor-based micromaterial and nanomaterial elements as an electrical signal generation media that can be utilized for the detection of neutrons so as to provide detectors that substantially eliminate the geometrical problem illustrated in FIG. 1. Such elements can be doped with different dopant profiles or undoped, configured as heterojunctions, and in some arrangements synthesized and used in the form of, for example, semiconductor dots, wires, or pillars on or in a semiconductor substrate embedded with matrixes of high cross-section neutron converter materials that can emit charged particles upon interaction with neutrons. These charged particles in turn can generate electron-hole pairs and thus detectable electrical current and voltage in the semiconductor elements.

Recent advances in microtechnology and nanotechnology provide new means to control the dimensionality, morphology, and chemical composition of such embedded materials at the atomic level and are incorporated into the present invention. Such manipulation of materials provides beneficial properties due to a combination of quantum confinement and surface to volume ratio effects. Semiconductor detectors of the present invention can be configured with a predetermined density of pillars that are individually coated with neutron converter materials. Such an arrangement provides a substantially small dead neutron active volume because the charge particles generated in the converter materials do not need to travel far to hit and lose energy in the semiconductor elements. The pillars can thus capture a substantial amount of the secondary radiations such as charged particles upon radiations with fluxes of neutrons.

Another example arrangement of the present invention includes a coating, such as, a polymer coating (e.g., Lucite, polyethylene, etc.) and having as one arrangement a variable thickness that is applied on a predetermined surface of a semiconductor material to detect slow and fast neutrons. Other beneficial detector embodiments of the present invention provide high neutron cross-section converter materials embedded in the chosen semiconductor detector elements. Such embedded converter materials are arranged in a matrix inside the semiconductor elements to enable substantially all of the desired radiations produced via the interactions with neutrons to be captured and detected by configuring such embedded materials to be within configured surroundings that are smaller than about the mean free path of charged particles generated from the reaction between neutrons and the predetermined neutron converter materials. Therefore, theoretically, there is no limitation on the amount of neutron converter materials to incorporate into detectors of the present invention because of the minimization of the dead volume in such three dimensional structures as disclosed herein.

### Specific Description

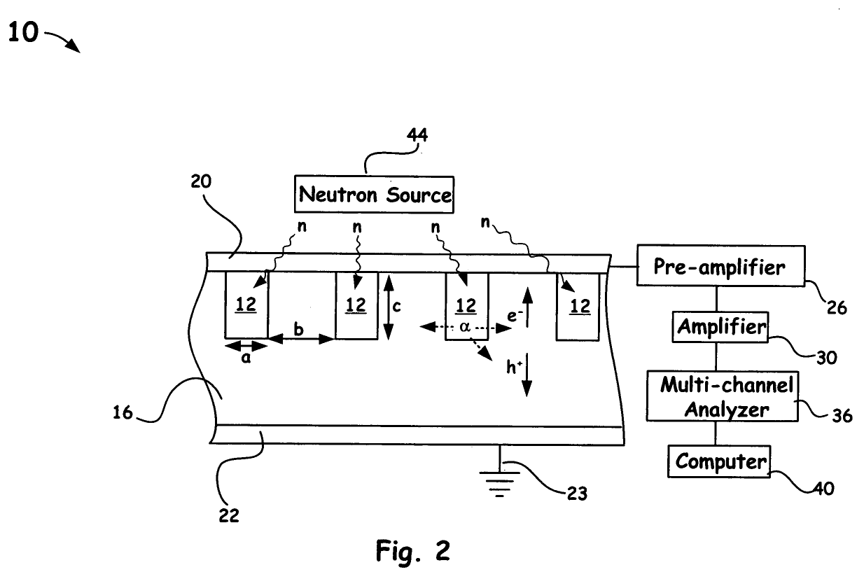

Returning now to the drawings, FIG. 2 shows a cross section of a beneficial generic neutron detector embodiment of the present invention, and is generally designated as reference numeral 10. Voids 12 of average horizontal dimension a, length c, and horizontal separations b, are created on a predetermined side of a piece of a semiconductor material 16, wherein such semiconductor materials can include, for example, silicon, silicon carbide, germanium, gallium arsenide, gallium phosphide, gallium nitride, indium phosphide, cadmium telluride, cadmium-zinc-telluride, mercuric iodide, and lead iodide. The dimensions of such voids and the semiconductor elements between the voids can be of micron and nanoscale dimensions as long as they are designed to efficiently capture neutrons and generate the electrical signals. Semiconductor material 16 can be doped with different dopant profiles or undoped in predetermined regions, or configured as heterojunctions. If doped, semiconductor material 16 is often arranged with one or more dopants. Voids 12 can be filled with the same or different neutron converting materials that have high cross sections with desired detection neutrons to not only enable neutron detection but to enable threshold neutron detectors. Such neutron converting materials can include, but are not limited to, Boron or Lithium or Gadolimium containing materials, such as, for example, Boron-10 (¹⁰B) and Lithium-7 (⁷Li), to detect thermal neutrons, thorium to detect fast neutrons, or any hydrogen rich matter (e.g., Lucite and polyethylene) to thermalize fast neutrons thereby detecting thermal neutrons.

Electrodes 20 and 22 are deposited on both sides of semiconductor material 16. A predetermined electrode 22 is grounded 23 and another predetermined electrode 20 is often connected to a pre-amplifier 26, followed by an amplifier 30, a multi-channel analyzer 36, and then a computer 40 to analyze the electrical signals. In a method of operation, upon the impingement of neutron flux (denoted by n and shown with accompanying arrows) from a neutron source 44 onto detector 10, predetermined neutron converter materials (not shown) disposed within voids 12 react with such impinging neutrons react to generate radiations such as charged particles (e.g., alpha particles a as denoted in FIG. 2) and gamma rays. The desired particles and/or rays then travel in random directions (shown by dashed arrows) out of the neutron converter materials to the semiconductor and generate electron-hole pairs (denoted as h+ and e− in FIG. 2). A predetermined voltage, as determined by the doping profile of semiconductor material 16, which is applied to electrodes 20 and 22, then promotes the collection of electrical signals that correlate to such impinging neutrons so as to be detected by the electronic detection setup and processed by computer 40.

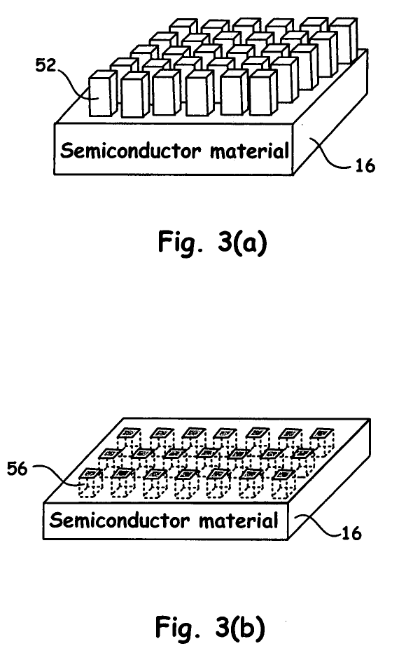

The three dimensional structures of the semiconductor material 16 that contains the voids can be configured in many possible beneficial arrangements, such as, pillar structures 52 (only one labeled for simplicity), such as pixilated structures, coupled with a semiconductor material 16, as shown in FIG. 3(a), and a plurality of pit structures 56 (only one labeled for simplicity) configured from a semiconductor material 16, as shown in FIG. 3(b). Such one or more pillars 52, as shown in FIG. 3(a), and one or more pits 56, as shown in FIG. 3(b), can be square, circular, hexagonal, or other forms of cross sections. It is to be appreciated that as long as at least one dimension of the void is less than about the mean free path of the charged particles generated in the neutron converter materials, the other dimension of the pillars or pits can be increased to increase the neutron capture volume.

Another beneficial embodiment of the present invention is the use of structures, such as pillars, having predetermined dimensions, e.g., dimensions from at least about 10 nm to about 3000 nm in diameter. In such an arrangement, the pillars (or wires) can act as an individual semiconductor detector element if each of them is individually connected to the signal collection electronics.

Analysis of the signals from each pillar or groups of pillars can indicate the presence and directions of the charge particles produced in different regions of the neutron converter materials in the detector. This information can be used to infer the direction of the neutron impinging onto the neutron detector. Moreover, since a wire has a large surface-to-volume ratio, charged particles that are generated in the neutron converter materials and embedded in the dense semiconductor pillar matrix, only need to travel a very short distance in the neutron converter material to reach the semiconductor elements to generate electron-hole pairs and thus the electrical signals. Because such charged particles lose some of their energy when they travel inside a predetermined converter material, the minimization of the travel distance using such pillars and/or wires of the charged particles inside the neutron converter materials increases the active volume of the neutron converter materials and thus the efficiency of the neutron detector. Moreover, by tracking the directions and intensity of the electrical signals in the neutron detector of the design, as described above, the intensity of the neutron flux and the relative energy of the neutron flux can be determined.

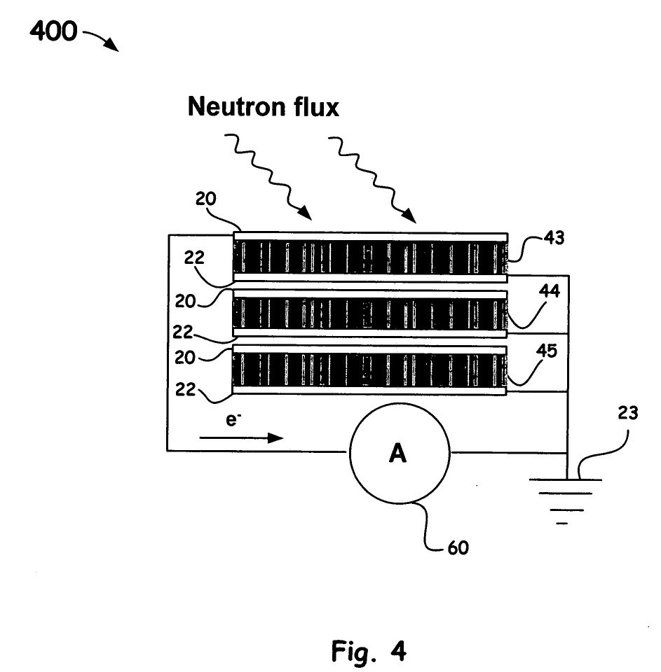

FIG. 4 shows a stacking detector configuration and is generally designated by reference numeral 400. Such an example configuration can include two or more configured detectors 10, as shown in FIG. 2 (i.e. each detector having semiconductors embedded with neutron converters) and arranged with electrodes 20 and 22 commonly coupled to a voltage source 60 and ground 23 respectively. This arrangement enables collection of all the signals (denoted as e⁻, as shown in FIG. 2) from each detector layer 43, 44, and 45, at the same time so as to increase the neutron capture volume. Such a stacking detector motif can be used to tailor the detection of neutron of different flux intensities. If the intensity of the neutron flux is too high, the electrical signals generated in one single layer of the neutron detector can be too fast and too intense to be detected by coupled electronics. However, since the stacking design can drastically increase the neutron capture volume, signals from each layer can be collected and compared to detect a large dynamic range of neutron flux intensity. To generate the complex three-dimensional semiconductor structures embedded with the neutron converter materials, we proposed two general strategies, the top-down and the bottom-up approaches.

The present invention will be more fully understood by reference to the following two example approaches for constructing detector embodiments of the present invention, which are intended to be illustrative of the present invention, but not limiting thereof.

### Top-Down Approach

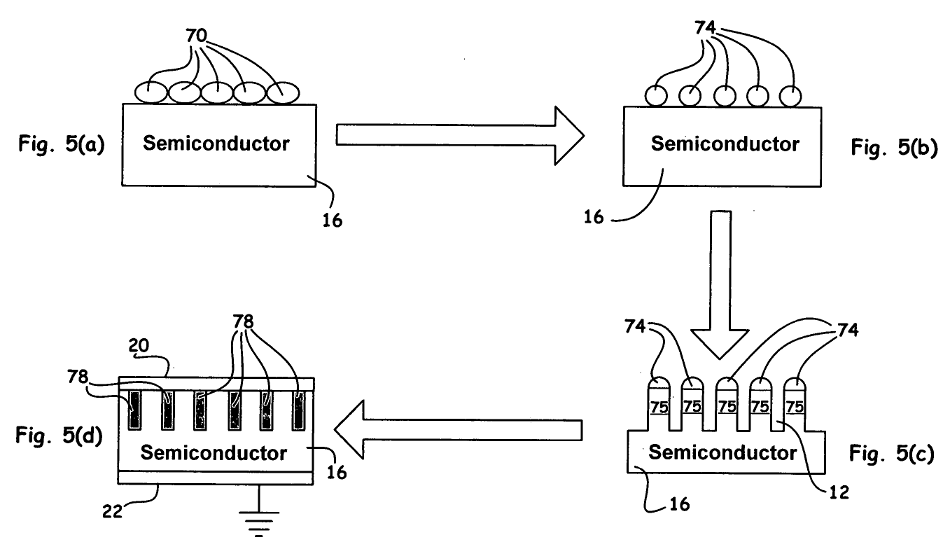

A top-down detector fabrication scheme (illustrated clock-wise) as shown in FIGS. 5(a)-(d). FIG. 5(a) shows a polymer etch resist patterned in the form of polystyrene beads 70 and configured on the top of a piece of semiconductor material 16, such as, a silicon wafer. Conventional photolithography techniques or e-beam lithography can also be utilized for the construction of such predetermined patterns. The size of the resist 74, as shown in FIG. 5(b), can be further tailored by plasma etching. The semiconductor substrate 16, as shown in FIG. 5(c), is then etched as masked by the beads 74, with either high density plasma, anisotropic chemical etching techniques, ion beam etching or laser ablation to generate pillar structures 75 or voids 12 (one void labeled for simplicity), which are then filled with neutron converter materials 78, as shown in FIG. 5(d), by either physical vapor deposition, chemical vapor deposition, or electrochemical deposition. After the lift of the polymer resist, contact metals and electrodes 20 and 22, as shown in FIG. 5(d), are deposited on the top and bottom sides of the substrates for electrical connection to the detection electronics.

In an example method for providing such a structure, as shown in FIGS. 5(a)-(d), a monolayer of polystyrene beads having diameters from about 10 nm to about 1000 nm is first deposited onto a semiconductor wafer by either spin coating, dip coating, or drop-drying technique. Then, oxygen and tetrafluoromethane plasma is applied to etch each polystyrene spheres to desired shape and size. The semiconductor is then etched by high density plasma with optimal etching conditions to generate the pillar structures. This fabrication scheme can be applied to generate pillar structures of different diameter and separations with polystyrene beads of different sizes and oxygen plasma etching conditions.

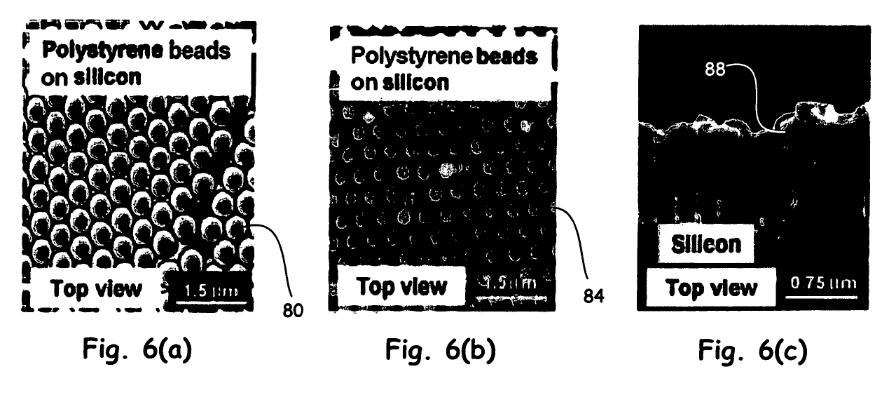

FIGS. 6(a)-6(c) shows scanning electron micrographs of pillar structures being constructed by nanosphere lithography at different stages of the fabrication scheme. FIG. 6(a) shows predetermined beads of material 80, such as, but not limited to, silicon or Polystyrene beads having diameters on the nanometer scale. In particular, as shown in FIG. 6(a), such beads 80 are about 490 nm in diameter (R500, Duke Scientifics, Palo Alto, Calif.), and spin-coated on a piece of a silicon wafer to form a monolayer of beads 80 with mostly hexagonally closed packed pattern. The beads are then etched with common etching techniques as understood by those skilled in the art, such as, for example, high density plasma, anisotropic chemical etching techniques, ion-beam etching or laser ablation. In the example as shown in FIG. 6(b), the beads are etched with a oxygen and CF4 plasma to tailor the size of the bead 84 resist. FIG. 6(c) shows the substrate after being etched with a high density plasma in a deep reactive ion etching chamber with SF6 and C4F8 using an optimized “Bosch” process to generate pillars 88 of diameter of about 300 nm in diameter and one micron in length.

### Bottom-Up Approach

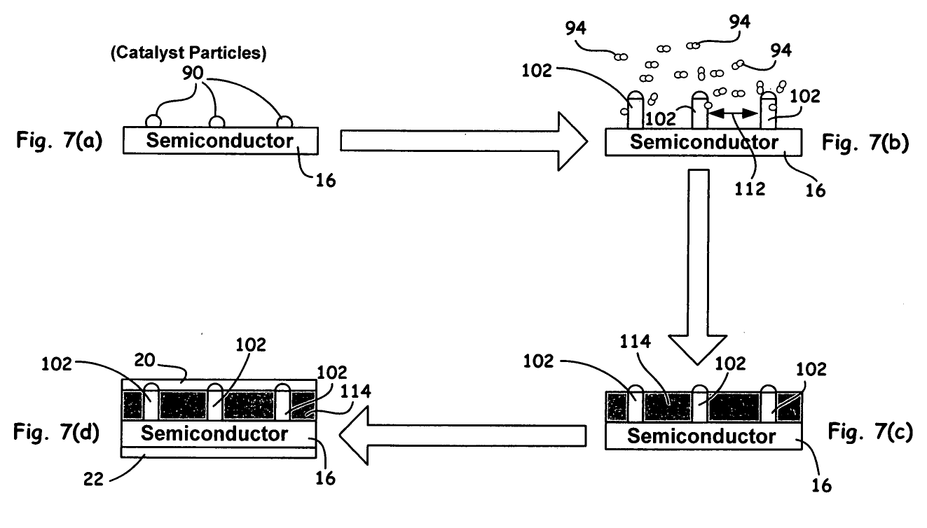

FIGS. 7(a)-(d) show a bottom-up approach for the fabrication of proposed neutron semiconductor detectors. Such a bottom-up detector fabrication scheme, as shown in FIGS. 7(a)-(d), can be used to generate the pillar semiconductor structures, as shown in FIGS. 5(a)-(d). In particular, FIG. 7(a) shows metal catalyst particles 90, such as, but not limited to, gold and copper that are patterned on the top of a piece of a semiconductor material 16, such as, a silicon wafer, by evaporation of metals or deposition of metal colloids of well-defined size. Substrate 16, as shown in FIG. 7(b), is then put in a chemical vapor deposition chamber (not shown) in which appropriate pre-cursors of semiconductor gases 94 are supplied to the catalyst to synthesize semiconductor wires 102 by the vapor-liquid-solid mechanism. The space 112 (denoted by the double arrows, as shown in FIG. 5(b)) between the pillar structures 102 are then filled with neutron converter materials 114, as shown in FIG. 5(c), by either physical vapor deposition, chemical vapor deposition, or electrochemical deposition. FIG. 6(d) shows that after the lift of the polymer resist, contact metals and electrodes 20 and 22 are deposited on the top and bottom sides of the substrates for electrical connection to the detection electronics.

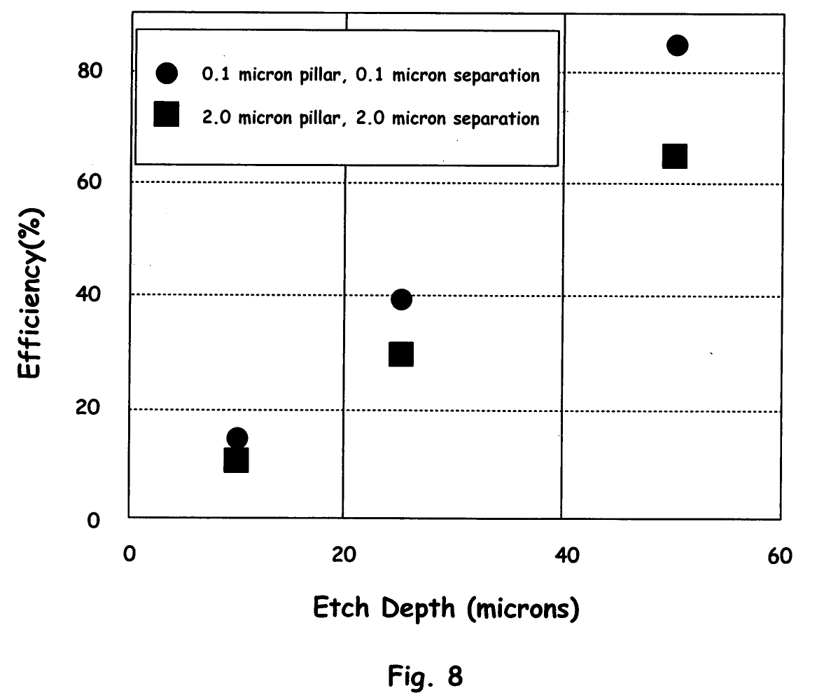

FIG. 8 shows example data that indicates that the detector efficiency reaches about 65% when using an example etch depth of 50 μm and a pillar width (and converter width) of 2 μm. For a desired designed structure as disclosed herein, e.g., having about a 100 nm pillar width and an etch depth of 50 μm, the corresponding neutron detection efficiency increases up to about 85%, which is 30% more than micron-sized counterparts. Hence, detector designs of the present invention are clearly ultra-efficient when compared with the current state of the art solid-state neutron detector with only 2% neutron detection efficiency.

### Top-Down Approach with High Aspect Ratio

As shown by the data in FIG. 8, with the increased etch depth and backfill with a neutron conversion material, a near complete thermal neutron capture is theoretically possible. A semiconductor of diode material formed by chemical vapor deposition or ion implantation can be grown with a pn or pin structure configuration. This requires anisotropic features with an etch depth of near 50 μm with an aspect ratio of 1:25 for the 2 μm diameter pillar detector geometry as an specific example for the case of Boron 10 as the neutron conversion material, (where a 2 micron spacing is chosen to satisfy the range requirement). Adequate masking materials and vertical etched features with smooth sidewalls are also required. Masking materials can include photoresist, metals and or oxides. The pillar can be etched with plasma processing, anisotropic chemical etching, ion beam etching and/or laser ablation. The neutron conversion material can be deposited by physical vapor deposition, chemical vapor deposition or electrochemical deposition. A top planarization step may be required before the top metal electrode is formed, this can be done by lapping, wet chemical etching or plasma processing or a combination thereof. An interlayer dielectric between the pillar and the neutron conversion material may be needed to reduce surface currents, which can be implemented for example by an oxide, nitride and or polyimide (not shown in FIG. 5d).

Accordingly, designing radiation detectors based on materials of three dimensional hierarchical structures at the micro and nano scale has the potential to yield drastic improvements in areas such as flexibility, durability, sensitivity, increased detector area, improved electrical signal output, and energy resolution for the next generation of neutron detectors.

Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The invention claimed is:

1. An apparatus for detecting neutrons, comprising:
a substrate capable of producing electron-hole pairs upon interaction with one or more reaction-produced particles;
a plurality of embedded converter materials extending into said substrate from only a single predetermined surface of said substrate, wherein said embedded converter materials are configured to release said reaction-produced particles upon interaction with one or more received neutrons to be detected, and wherein said embedded converter materials are adapted to have at least one dimension that is less than about a mean free path of said one or more reaction-produced particles to efficiently result in creating said electron-hole pairs; and
at least one pair of non-embedded electrodes coupled to predetermined surfaces of said substrate, wherein each electrode of said at least one pair of electrodes comprises a substantially linear arrangement, and wherein signals from resulting electron-hole pairs as received from a predetermined said at least one pair of electrodes are indicative of said received neutrons.

2. The apparatus of claim 1, wherein said substrate is configured with a matrix of pillars having resultant voids therebetween for receiving said embedded converter materials.

3. The apparatus of claim 2, wherein at least one dimension of said resultant voids comprises a dimension as determined by the range of said reaction-produced particles.

4. The apparatus of claim 2, wherein said substrate is configured with a matrix of pits for receiving said embedded converter materials.

5. The apparatus of claim 2, wherein said pillars are configured with at least one cross section shape selected from: a square shape, a circular shape, and a hexagonal shape.

6. The apparatus of claim 4, wherein said pits are configured with at least one cross section shape selected from: a square shape, a circular shape, and a hexagonal shape.

7. The apparatus of claim 1, wherein said embedded converter materials are selectively the same or different and comprise at least one predetermined converter material comprising: Gadolinium, Boron, and Lithium containing materials.

8. The apparatus of claim 7, wherein said at least one predetermined converter material further comprises. Boron-10 (¹⁰B), Lithium-6 (⁶Li), Lithium-7 (⁷Li), thorium, a polymer, and/or Gadolinium.

9. The apparatus of claim 2, wherein said pillars are individually coupled to signal collection electronics so as to indicate the direction of said received neutrons.

10. The apparatus of claim 1, wherein said substrate comprises a semiconductor selected from: silicon, silicon carbide, germanium, gallium arsenide, gallium phosphide, gallium nitride, indium phosphide, cadmium telluride, cadmium-zinc-telluride, mercuric iodide, and lead iodide.

11. An apparatus for detecting neutrons, comprising:
a plurality of neutron detectors arranged in a stacked configuration, wherein each said neutron detector further comprises:
(a) a substrate capable of producing electron-hole pairs upon interaction with one or more reaction-produced particles;
(b) a plurality of embedded converter materials extending into said substrate from only a single predetermined surface of said substrate, wherein said embedded converter materials are configured to release said reaction-produced particles upon interaction with one or more received neutrons to be detected, and wherein said embedded converter materials are adapted to have at least one dimension that is less than about a mean free path of said one or more reaction-produced particles to efficiently result in creating said electron-hole pairs so as to measure said received neutrons; and
(c) at least one pair of non-embedded electrodes coupled to predetermined surfaces of said substrate, wherein each electrode of said at least one pair of electrodes comprises a substantially linear arrangement; and wherein signals from resulting electron-hole pairs as received from a predetermined said at least one pair of electrodes are indicative of said received neutrons; and
wherein signals from a predetermined said neutron detector arranged in said stacked configuration can be collected and compared to detect a large dynamic range of neutron flux intensity.

12. The apparatus of claim 11, wherein said substrate is configured with a matrix of pillars having resultant voids therebetween for receiving said embedded converter materials.

13. The apparatus of claim 12, wherein at least one dimension of said resultant voids comprises a dimension as determined by the range of said reaction-produced particles.

14. The apparatus of claim 12, wherein said substrate is configured with a matrix of pits for receiving said embedded converter materials.

15. The apparatus of claim 12, wherein said pillars are configured with a cross section shape that comprises: a square shape, a circular shape, and a hexagonal shape.

16. The apparatus of claim 14, wherein said pits are configured with a cross section shape that comprises: a square shape, a circular shape, and a hexagonal shape.

17. The apparatus of claim 11, wherein said embedded converter materials are selectively the same or different and comprise at least one predetermined converter material comprising: Gadolinium, Boron, and Lithium containing materials.

18. The apparatus of claim 17, wherein said at least one predetermined converter material further comprises: Boron-10 (¹⁰B), Lithium-6 (⁶Li), Lithium-7 (⁷Li), thorium, a polymer, and/or Gadolinium.

19. The apparatus of claim 12, wherein said pillars are individually coupled to signal collection electronics so as to indicate the direction of said received neutrons.

20. The apparatus of claim 11, wherein said substrate comprises a semiconductor selected from: silicon, silicon carbide, germanium, gallium arsenide, gallium phosphide, gallium nitride, indium phosphide, cadmium telluride, cadmium-zinc-telluride, mercuric iodide, and lead iodide.

21. A method for producing a detector, comprising:
configuring a substrate with a matrix of voids that extend from only a single predetermined surface of said substrate, wherein said substrate is capable of producing electron-hole pairs upon interaction with one or more reaction-produced particles; and
embedding converter materials within said voids, wherein said embedded converter materials are configured to release said reaction-produced particles upon interaction with one or more received neutrons to be detected, and wherein said embedded converter materials are adapted to have at least one dimension that is less than about a mean free path of said one or more reaction-produced particles to efficiently result in creating said electron-hole pairs, which are indicative of said received neutrons; and
coupling pairs of non-embedded electrodes to predetermined surfaces of said substrate, wherein each electrode of said pairs of electrodes comprises a substantially linear configuration, and wherein signals from resulting electron-hole pairs as received from respective said pairs of electrodes are indicative of said received neutrons.

22. The method of claim 21, wherein said configuring step further comprises: configuring a matrix of pillars to provide said matrix of voids therebetween.

23. The method of claim 21, wherein at least one dimension of each of said voids comprises a dimension as determined by the range of said reaction-produced particles.

24. The method of claim 22, wherein said step of configuring said matrix of pillars further comprises depositing a pattern of a metal catalyst.

25. The method of claim 22, wherein said step of configuring said matrix of pillars further comprises growing said pillars via a vapor-liquid-solid mechanism.

26. The method of 22, wherein said step of configuring said matrix of pillars further comprises: chemical vapor deposition or ion implantation of predetermined crystals.

27. The method of claim 22, wherein said step of configuring said matrix of pillars further comprises at least one technique selected from: patterning using polystyrene beads as a mask, conventional photolithography, and e-beam photolithography.

28. The method of either claim 26 or claim 27, further comprising utilizing at least one configuring step selected from: plasma etching, anisotropic chemical etching, ion beam etching, and/or laser ablation.

29. The method of claim 22, wherein said pillars comprises least one desired cross-sectional shape selected from: a square shape, a circular shape, and a hexagonal shape for each of said pillars.

30. The method of claim 22, wherein an interlayer dielectric between said pillars and said neutron conversion is applied to remove surface currents.

31. The method of claim 21, further comprising planarizing prior to forming a top metal electrode.

32. The method of claim 31, wherein said planarizing step comprises at least one process selected from: lapping, wet chemical etching, and plasma processing.
